(19) United States
(12) Patent Application Publication
(10) Pub. No.: US 2015/0175723 A1
(43) Pub. Date: Jun. 25, 2015

(54) ELECTROCHEMICALLY DEGRADABLE POLYMERS

(71) Applicants: Pericles Calias, Melrose, MA (US); Marc d'Alarcao, Malden, MA (US)

(72) Inventors: Pericles Calias, Melrose, MA (US); Marc d'Alarcao, Malden, MA (US)

(21) Appl. No.: 14/408,217

(22) PCT Filed: Jun. 13, 2013
(86) PCT No.: PCT/US13/45557

§ 371 Date: Dec. 15, 2014

Related U.S. Application Data
(60) Provisional application No. 61/661,185, filed on Jun. 18, 2012.

(51) Int. Cl. C08F 12/08; C09J 125/06

(52) U.S. Cl. CPC C08F 12/08; C09J 125/06

(57) ABSTRACT

The present invention discloses polymeric materials that incorporate a modified quinone core structure, which serves as a cross-linking agent or a monomeric unit within the polymer. These polymers can be efficiently degraded through electrochemical reduction. Moreover, the polymer's degradation rate can be tuned by making predictable structural changes. The disclosed polymer compositions can be used to produce electrochemically degradable commodities such as adhesives, concrete and the like.

### CROSS-REFERENCE TO RELATED PATENT APPLICATION

The present application claims the benefit of U.S. Provisional Application No. 61/661,185 entitled ELECTROCHEMICALLY DEGRADABLE POLYMERS and filed Jun. 18, 2012, the entire contents of which are incorporated herein by reference.

### FIELD OF INVENTION

The present invention relates to polymers that can be degraded in a controlled manner via electrochemical reduction.

### BACKGROUND

The routine use of synthetic polymers in industries, ranging from medicine to microfluidics to commodities, has led to a growing interest in synthesizing novel degradable polymers. Ideally, synthetic polymers should be non-toxic and capable of controlled rates of degradation. Applications of degradable polymers include drug delivery, tissue engineering, sutures, coatings, adhesives and sealants.

Epoxy polymers are formed by reacting an epoxide resin with a polyamine hardener. When mixed together, the amine groups of the hardener form covalent bonds with the epoxide groups of prepolymer resin molecules. This polymerization process, commonly known as curing, produces a heavily cross-linked polymer that is both rigid and strong. Epoxy polymers (e.g., adhesives) are known for their high-performance adhesive properties. Epoxy adhesives are versatile because they can be used on most surfaces including wood, glass, metal, stone and some plastics. Furthermore, epoxy adhesives can be made flexible or rigid, transparent or opaque, fast setting or slow setting, and are extremely resistant to both heat and chemicals. However, because of their strength, cured epoxy adhesives often cannot be removed without risking structural damage to a coated surface. In fact, some epoxy adhesives must be exposed to temperatures above 350° F. for degradation to occur. Thus, there is a need in the art for epoxy polymers with robust adhesive properties that can be easily reversed without damaging the structural integrity of the coated surface.

There is also a more general need for polymers that are capable of being degraded on demand. Unpredictable changes in environmental factors like pH, temperature, or ionic strength cause most biodegradable polymers to decompose at variable rates. Moreover, there is a need for polymer systems that permit users to alter the rate of degradation. The ability to degrade polymers on demand can solve problems in a wide array of industries. Examples include: (1) commodities, such as adhesives or concrete, where curing agents or releasing agents could be encapsulated in degradable polymers for action only when needed; (2) microfluidics and lithography, where tiny gates or masks made up of degradable polymers can be degraded on command; (3) medical applications such as drug delivery devices, surgical implants, fracture fixation, and scaffolding in tissue engineering; and (4) green technologies, where consumer plastics could be made more easily recyclable or disposable.

### SUMMARY

The present invention discloses polymeric materials that incorporate a modified quinone moiety, which is a cross-linking agent or a monomer in the polymer. The disclosed polymeric materials incorporate a core structure consisting of a quinone moiety surrounded by two alkyl arms terminating via an ester or amide linkage through which the desired cross-linking functionality may be appended. These polymers have the following characteristics: (1) efficiently degraded through electrochemical reduction of the quinone within the polymer, thereby leading to rapid release of the pendant chemical groups and degradation of the polymer; (2) the polymer degradation rate is tunable; (3) the redox properties can be tuned by making predictable structural changes; and (4) generally applicable to a wide variety of polymer types, including adhesives. The disclosed quinone-containing compositions can be used in the manufacture of electrochemically degradable commodities including, but not limited to, adhesives and concrete.

The invention is based, in part, upon the incorporation of a modified quinone polymer moiety, either to cross-link the polymer or as a monomer in the synthesis of the polymer. The terms “moiety,” “quinone moiety,” and “polymer moiety,” as used herein, encompass both polymer cross-linkers and monomeric components of polymers. The polymer cross-linking reagent or co-polymer reagent incorporates a core structure consisting of a quinone moiety surrounded by two alkyl arms terminating via an ester or amide linkage through which the desired cross-linking functionality may be appended. The polymer cross-linker can be customized to react via well-established cross-linking or polymerization chemistry by simply changing the pendant chemical groups. The alkyl arms are designed to make use of the well-established “trialkyl lock” phenomenon that results in rapid amide or ester cleavage upon reduction (see FIG. 1). Electrochemical reduction of the quinone within the polymer leads to rapid hydrolysis of the pendant chemical groups and degradation of the polymer.

The invention makes use of modified quinone moieties that can be incorporated into a polymer such that the resulting polymer can be controllably degraded through electrochemical reduction. The electrochemically degradable polymers can have the following core structure:

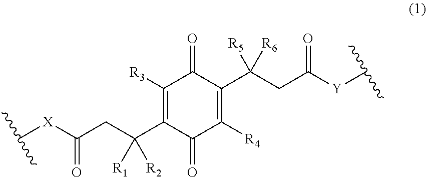

where R₁, R₂, R₃, R₄, R₅, and R₆ can be any functional group including, but not limited to, hydrogen, alkyl, aryl, alcohol, ether, thiol, thioether, amine, cyano, halo, nitro, ketone, aldehyde, ester, amide, thioester, carbonate, carbamate, and urea. The pendant groups X and Y can be derived by substitution of any of the following elements: oxygen (O), sulfur (S), selenium (Se), nitrogen (N), phosphorous (P), and arsenic (As). The two groups X and Y can be identical or different. Any chemical moiety used as a reactive group in polymer cross-linking or as a reactive group in polymerization can be appended to the quinone structure at X or Y. For example, the pendant groups X and Y can be any functional groups subject to degradation upon reduction of the quinone. Representative groups at X and Y include, but are not limited to groups containing epoxide, vinyl sulfone, alkyl halide, alkene, amine, alcohol, acid halide, acid anhydride, sulfate, phosphate, isocyanate, isothiocyanate, and thiol. Additional groups at X and Y include:

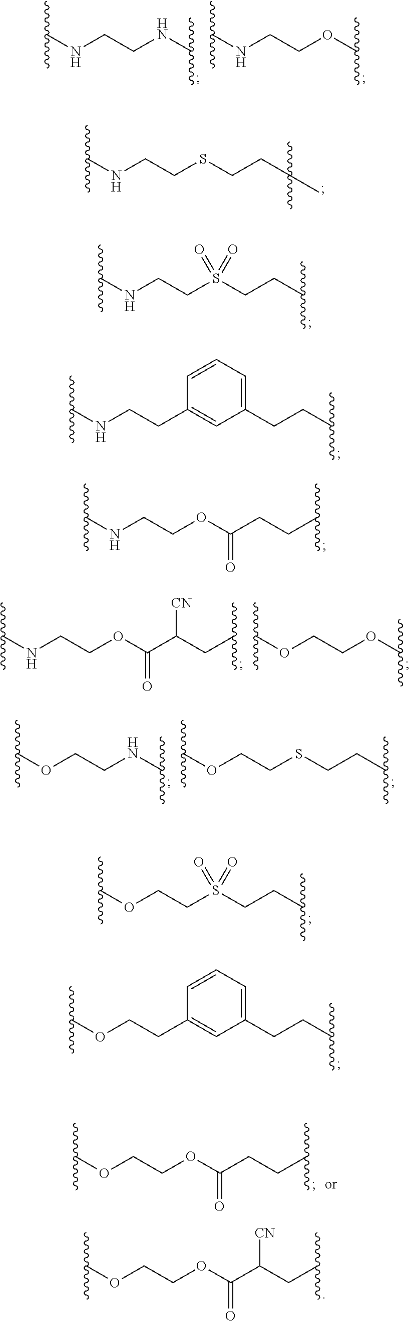

The resulting quinone structure could be used, as a cross-linker or monomer, in the synthesis of electrochemically degradable polymers. The disclosed polymeric materials can be controllably degraded through electrochemical reduction. Degradation can be accomplished by subjecting the polymer to an electric potential, a chemical reductant, or other agents capable of inducing chemical degradation. In one embodiment, the electrochemical reduction is induced by exposure to a change of electrical potential between about 0.05 to about 1.0 V relative to Ag/AgCl reference electrode or between about 0.5 to about 1.0 V relative to Ag/AgCl reference electrode. The Ag/AgCl (silver/silver chloride) reference electrode is used as the reference electrode of choice because it is stable and easily prepared. However, any technique for measuring electric potential may be used. The electric current producing device can provide either a constant current or variable current, e.g., one which varies in response to changes in one or more internal or external parameters.

Furthermore, the degradation rate of the disclosed polymeric materials is tunable. For example, previous studies on trialkyl-lock-based quinones demonstrate that amide linkages, such as those described herein, are cleaved much more slowly than ester linkages. In addition, the degradation rate of the disclosed electrically-degradable polymers can be modulated by varying the quinone structure at R₁, R₂, R₃, R₄, R₅, and R₆. Varying the chemical groups at R₁, R₂, R₃, R₄, R₅, and R₆ affects the reduction potential of the polymer cross-linking reagent or co-polymer reagent, thus providing a means for controlling the rate, extent, or conditions of polymer degradation. For example, having electron-donating groups like methoxy or dimethylamino at R₃ and/or R₄ can make the quinone less prone to reduction and thus retard polymer degradation. Conversely, electron-withdrawing groups like methoxy-carbonyl, halogen, or cyano at R₃ and/or R₄ can make the quinone more prone to reduction and thus accelerate polymer degradation.

In one embodiment, the invention provides an electrochemically degradable polymer comprising a quinone compound of the formula (1) wherein the polymer moiety is capable of degrading upon exposure to a change in electric potential. The quinone compound can be used to cross-link one or more monomers selected from styrene, acrylates, methacrylates, 1,3-butadiene, isoprene, 2-vinylpyridine, ethylene oxide, acrylonitrile, methyl vinyl ketone, alpha-cyanoacrylate vinylidene cyanide, propylene, butene, isobutylene, phosphorus acid, phosphonous acid, phosphinous acid, phosphoric acid, phosphonic acid, phosphinic acid, methylene bis(phosphonic acid), poly(vinylphosphonic acid), aziridine, spermine, cadaverine, and putrecine.

### BRIEF DESCRIPTION OF THE FIGURES

FIG. 1 is a schematic illustration of the proposed trialkyl-lock-based degradation of a cross-linked polymer upon reduction.

FIG. 2 illustrates kinetic studies performed on an electrochemically degradable cross-linking reagent EDCR-10.

### DETAILED DESCRIPTION

The practice of the present invention employs, unless otherwise stated, conventional methods of organic and polymeric chemistry within the skill of the art. Such techniques are fully described in the literature.

The terminology used herein is for describing specific embodiments and is not meant to be limiting. Unless defined otherwise, all scientific and technical terms are to be construed as having the same meaning as those commonly used in the art to which they pertain. For the purposes of the present invention, the following terms are defined below:

“Alkyl groups” include straight chain, branched chain, or cyclic alkyl groups having 1 to 20 carbons or the number of carbons indicated herein. In some preferred embodiments, an alkyl group has from 1 to 16 carbon atoms. Examples of straight chain alkyl groups include groups such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups. “Lower alkyl” refers to straight or branched chain alkyl groups having 1 to 4 carbons. In some embodiments, the alkyl groups may be substituted alkyl groups. Alkyl group substituents may be the same or different, and include halo, cycloalkyl, hydroxy, alkoxy, amino, carbamoyl, acylamino, aroylamino, carboxy, alkoxycarbonyl, aralkyloxycarbonyl, or heteroaralkyloxycarbonyl. Representative alkyl groups include methyl, trifluoromethyl, cyclopropylmethyl, cyclopentylmethyl, ethyl, n-propyl, i-propyl, n-butyl, i-butyl, n-pentyl, 3-pentyl, methoxyethyl, carboxymethyl, methoxycarbonylethyl, benzyloxycarbonylmethyl, and pyridylmethyloxycarbonylmethyl.

The term “alkylene,” as used herein, refers to straight or branched bivalent hydrocarbon chains having 1 to 6 carbons. The alkylene groups may be substituted alkylene groups. Alkylene group substituents may be the same or different, and include halo, cycloalkyl, hydroxy, alkoxy, carbamoyl, carboxy, cyano, aryl, heteroaryl, or oxo. Preferred alkylene groups are the lower alkylene groups having 1 to 4 carbons. Representative alkylene groups include methylene, ethylene, and the like.

The term “amine” (or “amino”), as used herein, refers to —NHR and —NRR′ groups, where R, and R′ are independently hydrogen, or a substituted or unsubstituted alkyl, acyl, alkenyl, alkynyl, cycloalkyl, aryl or aralkyl group. Alternatively, the term amine refers to —NHR and —NRR′ groups, where R and R′ taken together with the N through which R and R′ are linked to form a 4- to 7-membered aza heterocyclyl. Examples of amino groups include —NH₂, methylamino, dimethylamino, ethylamino, diethylamino, propylamino, isopropylamino, phenylamino, benzylamino, and the like.

The term “aryl,” as used herein, refers to an aromatic monocyclic or multicyclic ring system having 3 to 14 carbons. In some preferred embodiments, an aryl group has from 6 to 10 carbon atoms. In some embodiments, the aryl groups may be substituted aryl groups, which may be the same or different. Representative aryl groups include phenyl, naphthyl, furyl, thienyl, pyridyl, indolyl, quinolinyl, isoquinolinyl and the like.

“Substituted” refers to a chemical group, as described herein, that further includes one or more substituents, such as lower alkyl (including substituted lower alkyl such as haloalkyl, hydroxyalkyl, aminoalkyl), aryl (including substituted aryl), acyl, halogen, hydroxy, amino, alkoxy, alkylamino, acylamino, thioamido, acyloxy, aryloxy, aryloxyalkyl, carboxy, thiol, sulfide, sulfonyl, oxo, both saturated and unsaturated cyclic hydrocarbons (e.g., cycloalkyl, cycloalkenyl), cycloheteroalkyls and the like. These groups may be attached to any carbon or substituent of the alkyl, alkenyl, alkynyl, aryl, cycloheteroalkyl, alkylene, alkenylene, alkynylene, arylene, hetero moieties. Additionally, the substituents may be pendent from, or integral to, the carbon chain itself.

A. Polymeric Structures

The present invention makes use of modified quinone moieties that can be incorporated into a polymer such that the resulting polymers can be controllably degraded via electrochemical reduction. The physical properties of the electrochemically degradable polymer can be modulated by varying the substituted monomers that are appended to the quinone cross-linker. The polymer's physical properties are crucial in determining polymer consistency and the types of processing steps the polymer can withstand. Such information is useful in pinpointing which applications a given polymer is best suited for.

In accordance with one aspect, an electrically-degradable polymer is provided, where the electrically-degradable polymer includes a quinone moiety, which is a cross-linking agent in the polymer, of formula (1):

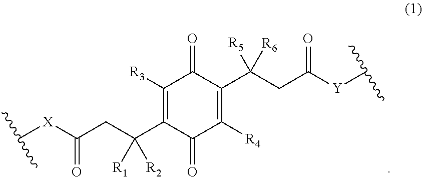

In formula (1), R₁, R₂, R₃, R₄, R₅, and R₆ are selected from hydrogen, alkyl, aryl, alcohol, ether, thiol, thioether, amine, cyano, halo, nitro, ketone, aldehyde, ester, amide, thioester, carbonate, carbamate, and urea, and X and Y can be the same or different and each X and Y is, independently, a substituted amine or ether, wherein at least one of X and Y is capable of degradation upon reduction of the quinone, such that the polymer moiety is capable of degrading upon exposure to a change in electric potential.

In some embodiments, each X and Y of the quinone moiety is independently

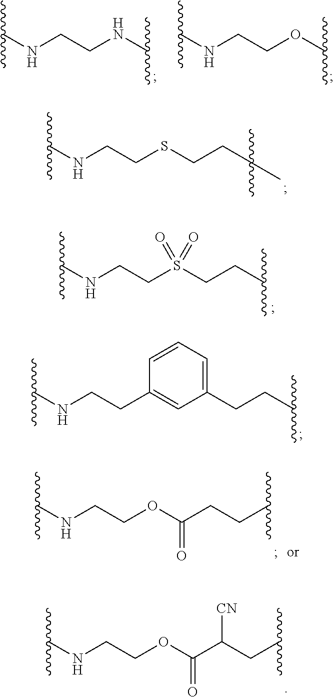

In other embodiments, each X and Y of the quinone moiety is independently

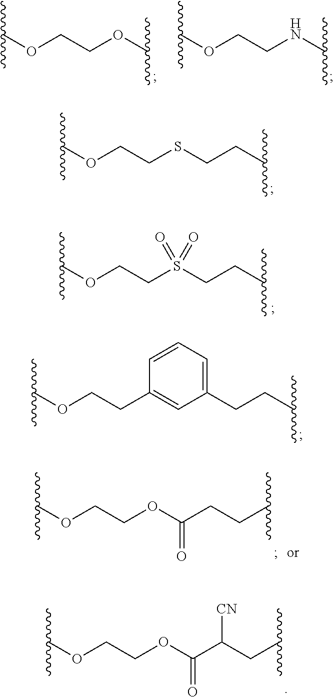

In some embodiments, the polymer that is cross-linked comprises monomers selected from styrene, acrylates, methacrylates, 1,3-butadiene, isoprene, 2-vinylpyridine, ethylene oxide, acrylonitrile, methyl vinyl ketone, alpha-cyanoacrylate vinylidene cyanide, propylene, butene, isobutylene, phosphorus acid, phosphonous acid, phosphinous acid, phosphoric acid, phosphonic acid, phosphinic acid, methylene bis(phosphonic acid), poly(vinylphosphonic acid), aziridine, spermine, cadaverine, and putrecine.

In some embodiments, the polymer is capable of degrading upon exposure to a change in electric potential of at least 0.05 V.

In accordance with another aspect, an electrically-degradable adhesive polymer is provided, where the electrically-degradable adhesive polymer includes a quinone moiety, which is a cross-linking agent in the polymer, wherein the quinine moiety has the formula:

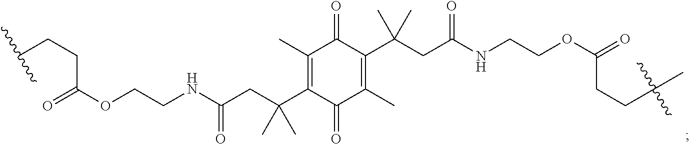 [SMILES: *CCC(=O)OCCNC(=O)CC(C)(C)C1=C(C)C(=O)C(C(C)(C)CC(=O)NCCOC(=O)CC*)=C(C)C1=O]

prepared from a cross-linker of the formula:

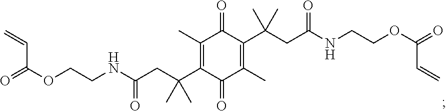 [SMILES: C=CC(=O)OCCNC(=O)CC(C)(C)C1=C(C)C(=O)C(C(C)(C)CC(=O)NCCOC(=O)C=C)=C(C)C1=O]

and where the polymer is capable of degrading upon exposure to a change in electric potential.

In accordance with yet another aspect, an electrically-degradable adhesive polymer is provided, where the electrically-degradable adhesive polymer includes a quinone moiety, which is a cross-linking agent in the polymer, wherein the quinine moiety has the formula:

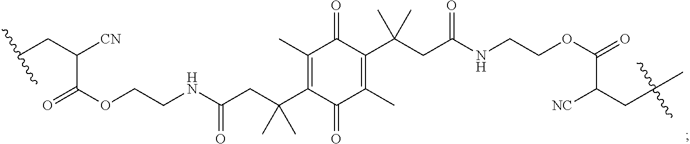 [SMILES: *CC(C#N)C(=O)OCCNC(=O)CC(C)(C)C1=C(C)C(=O)C(C(C)(C)CC(=O)NCCOC(=O)C(C#N)C*)=C(C)C1=O]

prepared from a cross-linker of the formula:

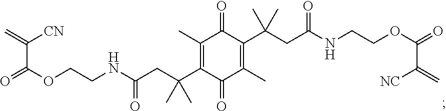 [SMILES: C=C(C#N)C(=O)OCCNC(=O)CC(C)(C)C1=C(C)C(=O)C(C(C)(C)CC(=O)NCCOC(=O)C(=C)C#N)=C(C)C1=O]

and wherein the polymer is capable of degrading upon exposure to a change in electric potential.

In accordance with another aspect, an electrically-degradable adhesive polymer is provided, where the electrically-degradable adhesive polymer includes a quinone moiety, which is a cross-linking agent in the polymer, wherein the quinine moiety has the formula:

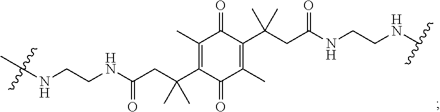 [SMILES: *NCCNC(=O)CC(C)(C)C1=C(C)C(=O)C(C(C)(C)CC(=O)NCCN*)=C(C)C1=O]

prepared from a cross-linker of the formula:

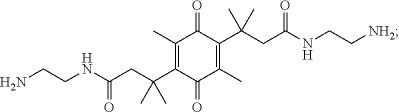

and wherein the polymer is capable of degrading upon exposure to a change in electric potential.

In accordance with yet another aspect, an electrically-degradable adhesive polymer is provided, where the electrically-degradable adhesive polymer includes a quinone moiety, which is a cross-linking agent in the polymer, wherein the quinine moiety has the formula:

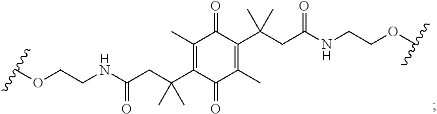 [SMILES: *OCCNC(=O)CC(C)(C)C1=C(C)C(=O)C(C(C)(C)CC(=O)NCCO*)=C(C)C1=O]

prepared from a cross-linker of the formula:

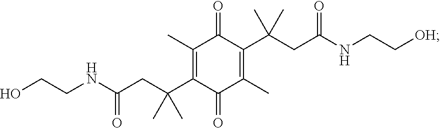 [SMILES: CC1=C(C(C)(C)CC(=O)NCCO)C(=O)C(C)=C(C(C)(C)CC(=O)NCCO)C1=O]

and wherein the polymer is capable of degrading upon exposure to a change in electric potential.

In one embodiment, the invention provides an electrochemically degradable polymer comprising a quinone compound of the formula (1) wherein the polymer moiety is capable of degrading upon exposure to a change in electric potential. The quinone compound can be used to cross-link one or more monomers selected from styrene, acrylates, methacrylates, 1,3-butadiene, isoprene, 2-vinylpyridine, ethylene oxide, acrylonitrile, methyl vinyl ketone, alpha-cyanoacrylate vinylidene cyanide, propylene, butene, isobutylene, phosphorus acid, phosphonous acid, phosphinous acid, phosphoric acid, phosphonic acid, phosphinic acid, methylene bis(phosphonic acid), poly(vinylphosphonic acid), aziridine, spermine, cadaverine, and putrecine. Electrochemically-degradable polymers cross-linked with the quinone compound can be made from polymerization, condensation or other reaction involving any combination of monomers.

The disclosed polymeric materials can be controllably degraded through electrochemical reduction. Degradation can be accomplished by subjecting the polymer to an electric potential, a chemical reductant, or other agents capable of inducing chemical degradation. In one embodiment, the electrochemical reduction is induced by exposure to a change of electrical potential between about 0.05 to about 1.0 V relative to Ag/AgCl reference electrode or between about 0.5 to about 1.0 V relative to Ag/AgCl reference electrode. The Ag/AgCl (silver/silver chloride) reference electrode is used as the reference electrode of choice because it is stable and easily prepared. However, any technique for measuring electric potential may be used. The electric current producing device can provide either a constant current or variable current, e.g., one which varies in response to changes in one or more parameters.

Furthermore, the degradation rate of the disclosed polymeric materials is tunable. The resulting polymers of the present invention contain one or more linkages selected from the group consisting of ester, ether, amine, amide, urethane, ketone, anhydride, carbonate, phosphodiester, silicone, disulfide, urea, and phenolic. The rate at which a particular polymer degrades depends on the type of linkage groups present within the polymer. For example, previous studies on trialkyl-lock-based quinones demonstrate that amide linkages, such as those described herein, are cleaved much more slowly than ester linkages. Thus the choice of linkage is based upon the desired use of the resulting polymer. For example, ester linkages are preferred in biodegradable polymers since the ester linkage undergoes hydrolysis under mildly basic conditions. In contrast, an amide linkage requires more stringent conditions and is not easily hydrolyzed, even under strongly acidic or basic conditions. The highly crystalline nature of polyamides in polymers such as nylon, retards degradation by preventing water molecules or other degrading agents from gaining access to the amide bonds.

Additionally, the degradation rate of the electrically-degradable polymers of the present invention can be modulated by varying the quinone structure at R₁, R₂, R₃, R₄, R₅, and R₆. Varying the chemical groups at R₁, R₂, R₃, R₄, R₅, and R₆. affects the reduction potential of the polymer cross-linking reagent or co-polymer reagent, thus providing a means for controlling the rate, extent, or conditions of polymer degradation. For example, having electron-donating groups like methoxyl or dimethylamino at R₃ and/or R₄ can make the quinone less prone to reduction and thus retard polymer degradation. Conversely, electron-withdrawing groups like methoxy-carbonyl, halogen, or cyano at R₃ and/or R₄ can make the quinone more prone to reduction and thus accelerate polymer degradation.

B. Electrically Degradable Adhesive Polymers

The present invention permits the scission of bonds in an adhesive polymer on demand by applying an electric current. Significantly, the technology is very versatile and should be applicable to a wide variety of adhesives, including UV/vis-curable acrylate-based adhesives, epoxy-type adhesives, cyanoacryate-based super glues, and polyurethane-like adhesives. Each of the following compositions is based on a different kind of known glass adhesive, but the resulting bond to the glass substrate can be reversed by applying an electric current.

In one embodiment, any of the polymers disclosed herein can be used as an electrochemically degradable adhesive formulation that acts as a “super glue” when mixed with methyl cyanoacrylate. In another embodiment, any of the polymers disclosed herein can be used as an epoxy glass adhesive that should degrade electrochemically. In another embodiment, any of the polymers disclosed herein can be used as a polymer that reacts with a commercial isocyanate resin to form a polyurethane-like bond to glass that is reversible upon electrochemical reduction.

In one embodiment, the invention provides an electrically-degradable adhesive polymer, which includes a quinone moiety, which is a cross-linking agent in the polymer, where the quinine moiety has the formula:

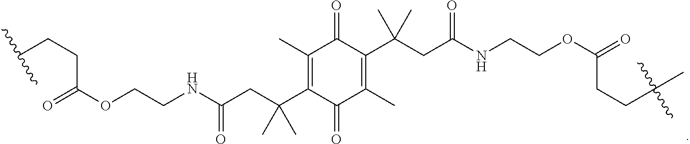 [SMILES: *CCC(=O)OCCNC(=O)CC(C)(C)C1=C(C)C(=O)C(C(C)(C)CC(=O)NCCOC(=O)CC*)=C(C)C1=O]

The aforementioned acrylic-based polymer can produce an electrochemically degradable adhesive formulation that can be cured by UV light when mixed with methylacrylate and a photo-initiator. The degree of cross-links in the cured adhesive will depend on the ratio of the cross-linked polymer to methylacrylate, and should allow both the strength and the degradability of the adhesive to be tuned by changing the formulation.

In another embodiment, the invention provides an electrically-degradable adhesive polymer, which includes a quinone moiety, which is a cross-linking agent in the polymer, where the quinine moiety has the formula:

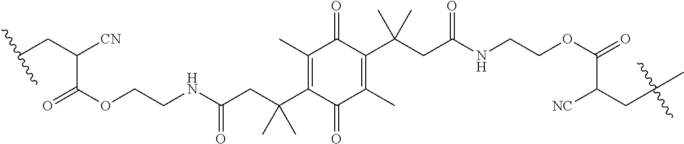 [SMILES: *CC(C#N)C(=O)OCCNC(=O)CC(C)(C)C1=C(C)C(=O)C(C(C)(C)CC(=O)NCCOC(=O)C(C#N)C*)=C(C)C1=O]

The aforementioned cyanoacrylate-based polymer can produce an electrochemically degradable adhesive formulation that acts as a “super glue” when mixed with methyl cyanoacrylate. Unlike the acrylic-based adhesive polymer, the cyanoacrylate-based cross-linking agent can be cured by atmospheric moisture.

In another embodiment, the invention provides an electrically-degradable adhesive polymer, which includes a quinone moiety, which is a cross-linking agent in the polymer, where the quinine moiety has the formula:

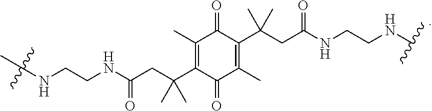 [SMILES: *NCCNC(=O)CC(C)(C)C1=C(C)C(=O)C(C(C)(C)CC(=O)NCCN*)=C(C)C1=O]

The aforementioned polymer can rapidly react with commercial epoxy resins in analogy to triethylenetetramine (TETA) to produce an epoxy glass adhesive that should degrade electrochemically.

In yet another embodiment, the invention provides an electrically-degradable adhesive polymer, which includes a quinone moiety, which is a cross-linking agent in the polymer, where the quinine moiety has the formula:

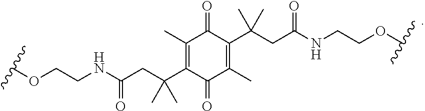 [SMILES: *OCCNC(=O)CC(C)(C)C1=C(C)C(=O)C(C(C)(C)CC(=O)NCCO*)=C(C)C1=O]

The aforementioned polymer can react with a commercial isocyanate resin to form a polyurethane-like bond to glass that is reversible upon electrochemical reduction.

### Examples

The following examples illustrate practice of the invention. The following examples are for illustrative purposes only and are not intended to limit the scope of the claimed subject matter in any way. Other embodiments may be utilized, and other changes may be made, without departing from the spirit or scope of the subject matter presented here.

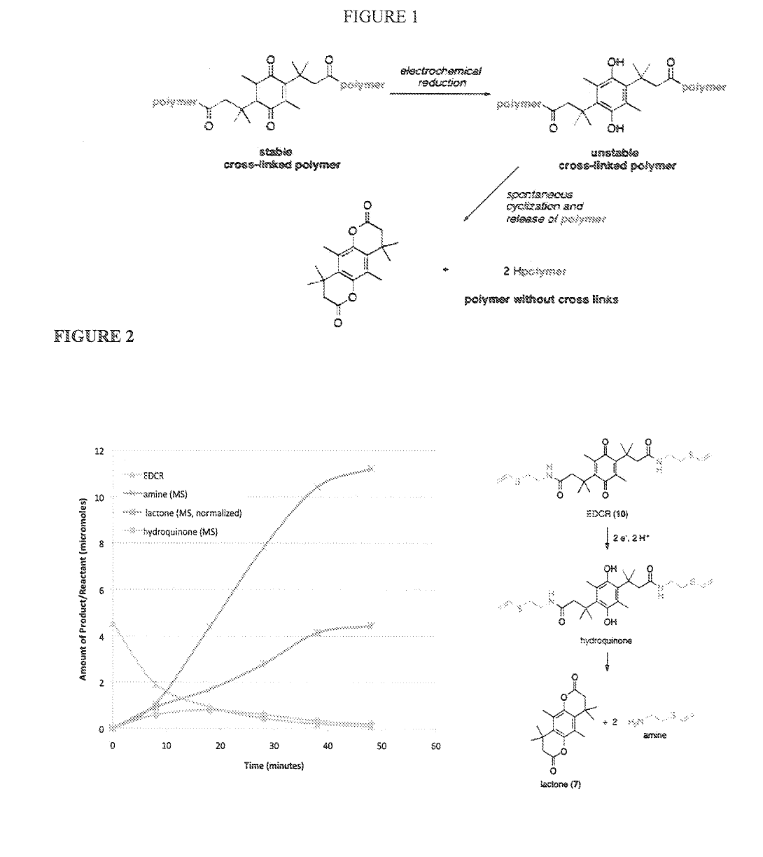

The present invention relates to polymeric materials capable of being degraded upon application of an electric current. Specifically, electrochemical reduction of the modified quinone moiety, which is a cross-linking agent or a monomer in the polymer, can cleave and thus efficiently degrade the polymer. See FIG. 1. The synthesis of several electrochemically-degradable cross-linking reagents (“EDCR”), including divinylsulfone-like EDCR, have been described using the methods of the present invention.

Kinetic studies were performed on an electrochemically degradable cross-linking reagent EDCR-10 to establish that reduction of the quinone moiety is accompanied by amide bond scission. See FIG. 2. The progress of amide cleavage was monitored by Liquid chromatography-mass spectrometry at different times after subjecting the solution containing the EDCR-10 to electrolysis. The results in FIG. 2 demonstrate clean conversion of the treated EDCR-10 to lactone, with a half-life on the order of 22 minutes.

As a proof of concept, polymers cross-linked with a divinylsulfone-like EDCR (cross-linker 1) have been synthesized:

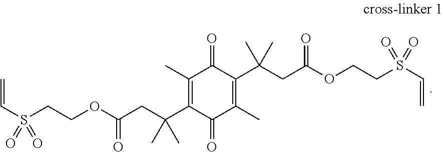 [SMILES: C=CS(=O)(=O)CCOC(=O)CC(C)(C)C1=C(C)C(=O)C(C(C)(C)CC(=O)OCCS(=O)(=O)C=C)=C(C)C1=O]

Cross-linker 1 was used to prepare hydrogels based on a carboxymethylcellulose (CMC) hydroxyethylcellulose (HEC) copolymer, where the hydrogels have crosslinkers of formula:

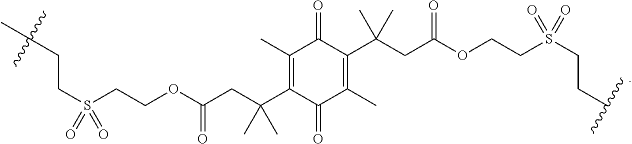 [SMILES: *CCS(=O)(=O)CCOC(=O)CC(C)(C)C1=C(C)C(=O)C(C(C)(C)CC(=O)OCCS(=O)(=O)CC*)=C(C)C1=O]

Polymers cross-linked with a divinylsulfone-like EDCR (cross-linker 2) have also synthesized:

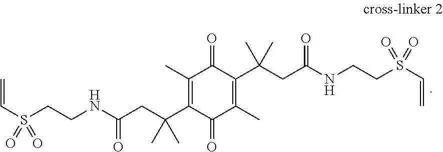 [SMILES: C=CS(=O)(=O)CCNC(=O)CC(C)(C)C1=C(C)C(=O)C(C(C)(C)CC(=O)NCCS(=O)(=O)C=C)=C(C)C1=O]

Cross-linker 2 was used to prepare hydrogels based on a carboxymethylcellulose (CMC) hydroxyethylcellulose (HEC) copolymer, where the hydrogels have crosslinkers of formula:

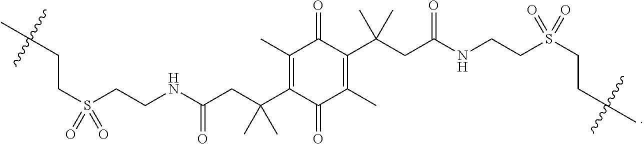 [SMILES: *CCS(=O)(=O)CCNC(=O)CC(C)(C)C1=C(C)C(=O)C(C(C)(C)CC(=O)NCCS(=O)(=O)CC*)=C(C)C1=O]

Polymers cross-linked with a divinylbenzene-like EDCR (cross-linker 3) have also been synthesized:

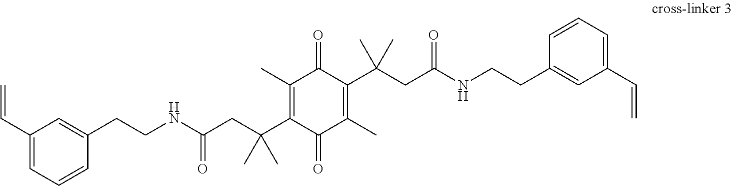 [SMILES: C=Cc1cccc(CCNC(=O)CC(C)(C)C2=C(C)C(=O)C(C(C)(C)CC(=O)NCCc3cccc(C=C)c3)=C(C)C2=O)c1]

Cross-linker 3 was used to prepare cross-linked polystyrene beads, where the beads have crosslinkers of formula:

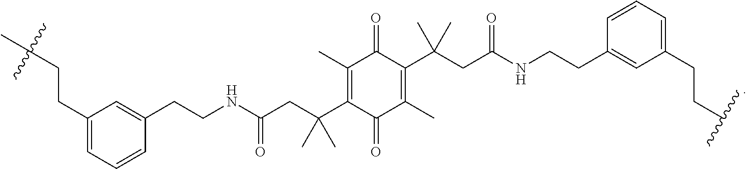 [SMILES: *CCc1cccc(CCNC(=O)CC(C)(C)C2=C(C)C(=O)C(C(C)(C)CC(=O)NCCc3cccc(CC*)c3)=C(C)C2=O)c1]

Both of the synthesized polymers, the CMC-HEC hydrogel and the polystyrene beads, were shown to be susceptible to electrochemical degradation. In the case of the CMC-HEC hydrogel, the gel was demonstrated to degrad upon application of an electric current (−1.5 V vs Ag/AgCl, 1.0 mA) by observing the increased rate of release of a colored dye (Ru(bpy)3Cl2) from the gel after electrolysis (16 h). In the case of the polystyrene beads, degradation of the cross-links was demonstrated by measuring the swelling ratio of the beads in toluene.

1. An electrically-degradable polymer comprising:
a quinone moiety, which is a cross-linking agent in the polymer, having the formula: 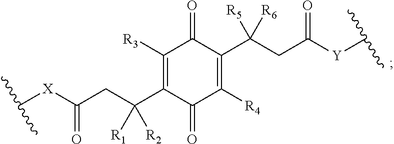
wherein R₁, R₂, R₃, R₄, R₅, and R₆ are selected from hydrogen, alkyl, aryl, alcohol, ether, thiol, thioether, amine, cyano, halo, nitro, ketone, aldehyde, ester, amide, thioester, carbonate, carbamate, and urea, and
X and Y can be the same or different and each X and Y is, independently, a substituted amine or ether, wherein at least one of X and Y is capable of degradation upon reduction of the quinone, such that the polymer moiety is capable of degrading upon exposure to a change in electric potential.

2. The electrically-degradable polymer of claim 1, wherein each X and Y of the quinone moiety is independently

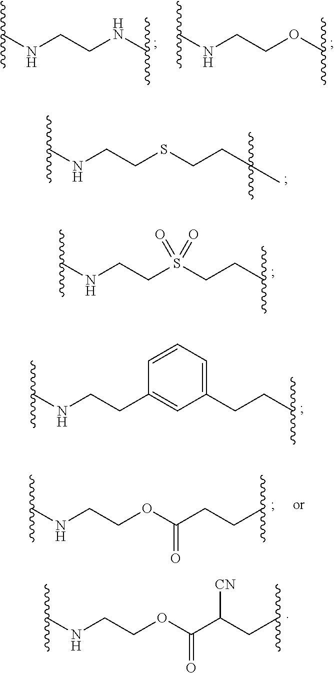

3. The electrically-degradable polymer of claim 1, wherein each X and Y of the quinone moiety is independently

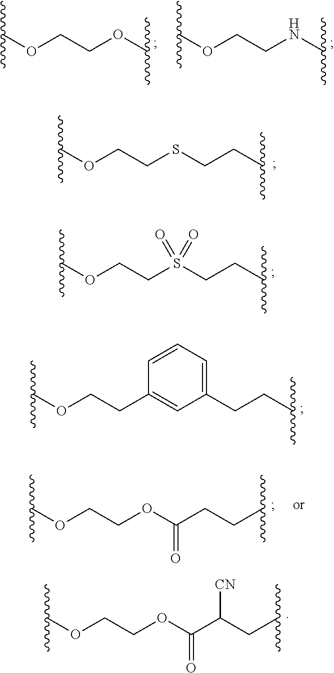

4. The electrically-degradable polymer of claim 1, wherein the polymer that is cross-linked comprises monomers selected from styrene, acrylates, methacrylates, 1,3-butadiene, isoprene, 2-vinylpyridine, ethylene oxide, acrylonitrile, methyl vinyl ketone, alpha-cyanoacrylate vinylidene cyanide, propylene, butene, isobutylene, phosphorus acid, phosphonous acid, phosphinous acid, phosphoric acid, phosphonic acid, phosphinic acid, methylene bis(phosphonic acid), poly(vinylphosphonic acid), aziridine, spermine, cadaverine, and putrecine.

5. The electrically-degradable polymer of claim 1, wherein the polymer is capable of degrading upon exposure to a change in electric potential of at least 0.05 V.

6. An electrically-degradable adhesive polymer comprising a quinone moiety, which is a cross-linking agent in the polymer, wherein the quinine moiety has the formula: 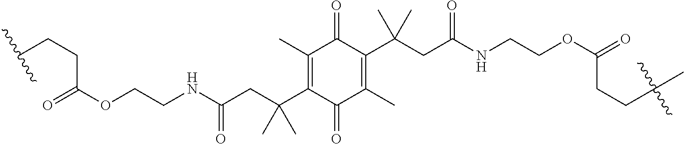 [SMILES: *CCC(=O)OCCNC(=O)CC(C)(C)C1=C(C)C(=O)C(C(C)(C)CC(=O)NCCOC(=O)CC*)=C(C)C1=O]
and wherein the polymer is capable of degrading upon exposure to a change in electric potential.

7. An electrically-degradable adhesive polymer comprising a quinone moiety, which is a cross-linking agent in the polymer, wherein the quinine moiety has the formula: 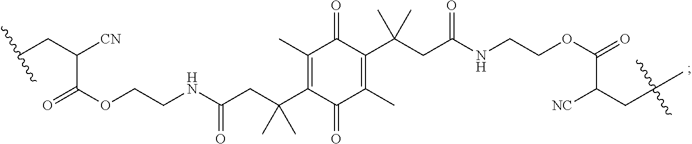 [SMILES: *CC(C#N)C(=O)OCCNC(=O)CC(C)(C)C1=C(C)C(=O)C(C(C)(C)CC(=O)NCCOC(=O)C(C#N)C*)=C(C)C1=O]
and wherein the polymer is capable of degrading upon exposure to a change in electric potential.

8. An electrically-degradable adhesive polymer comprising a quinone moiety, which is a cross-linking agent in the polymer, wherein the quinine moiety has the formula: 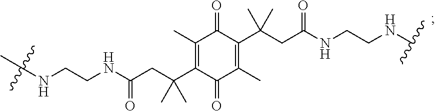 [SMILES: *NCCNC(=O)CC(C)(C)C1=C(C)C(=O)C(C(C)(C)CC(=O)NCCN*)=C(C)C1=O]
and wherein the polymer is capable of degrading upon exposure to a change in electric potential.

9. An electrically-degradable adhesive polymer comprising a quinone moiety, which is a cross-linking agent in the polymer, wherein the quinine moiety has the formula: 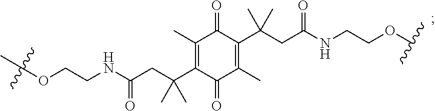 [SMILES: *OCCNC(=O)CC(C)(C)C1=C(C)C(=O)C(C(C)(C)CC(=O)NCCO*)=C(C)C1=O]
and wherein the polymer is capable of degrading upon exposure to a change in electric potential.
